(19) United States
(12) Patent Application Publication
(10) Pub. No.: US 2024/0057071 A1
(43) Pub. Date: Feb. 15, 2024

(54) PANEL SELECTION FOR UPLINK TRANSMISSION

(71) Applicant: Apple Inc., Cupertino, CA (US)

(72) Inventors: Haitong SUN, Cupertino, CA (US); Wei ZENG, Saratoga, CA (US); Weidong YANG, San Diego, CA (US); Hong HE, San Diego, CA (US); Oghenekome OTERI, San Diego, CA (US); Yushu ZHANG, Beijing (CN); Chunxuan YE, San Diego, CA (US); Huaning NIU, San Jose, CA (US); Dawei ZHANG, Saratoga, CA (US)

(73) Assignee: Apple Inc., Cupertino, CA (US)

(21) Appl. No.: 17/440,593

(22) PCT Filed: May 8, 2021
(86) PCT No.: PCT/CN2021/092461

§ 371 Date: Nov. 17, 2022

(51) Int. Cl. H04W 72/1268; H04L 5/00; H04W 72/231; H04W 72/566

(52) U.S. Cl. CPC H04W 72/1268; H04L 5/0051; H04W 72/231; H04W 72/566

(57) ABSTRACT

Some aspects include an apparatus, method, and computer program product for identifying a panel on user equipment (UE) for sounding reference signal (SRS) and/or physical uplink shared channel (PUSCH) communications. This panel selection may be applicable to codebook as well as non-codebook based PUSCH transmission schemes. In some aspects, a base station may provide the UE with an indication of one or more SRS resources and/or sets of SRS resources. The UE may then identify a panel corresponding to the indicated SRS resources and use this panel for PUSCH communications. In some aspects, the UE may apply prioritization scheduling when the UE uses different panels for SRS and PUSCH communications. This prioritization scheduling may address switching delays, which may occur when the UE switches between panels.

### BACKGROUND

### Field

Various aspects generally may relate to the field of wireless communications.

### SUMMARY

Some aspects of this disclosure include apparatuses and methods for selecting a panel at user equipment (UE) for sounding reference signal (SRS) and/or physical uplink shared channel (PUSCH) communications.

In some aspects, a method for configuring PUSCH communications at a UE may include receiving, at the UE from a base station, an indication of whether to use a codebook based transmission scheme or a non-codebook based transmission scheme for physical uplink shared channel (PUSCH) communications with the base station. The method may include receiving, at the UE from the base station, an indication of one or more sounding reference signal (SRS) resources corresponding to whether the UE uses the codebook based transmission scheme or the non-codebook based transmission scheme. The method may include identifying, at the UE, a panel including one or more antenna ports corresponding to the one or more SRS resources. The method may include configuring, at the UE, PUSCH transmission communications to use the panel including the one or more antenna ports.

In some aspects, when the UE uses a codebook based transmission scheme, the receiving may further include receiving, at the UE, a list identifying the one or more antenna ports of the UE for a SRS resource.

In some aspects, when the UE uses a codebook based transmission scheme, the receiving may further include receiving, at the UE, one or more SRS resource indicators (SRIs) identifying the one or more SRS resources corresponding to the panel.

In some aspects, when the UE uses a codebook based transmission scheme, the receiving may further include receiving, at the UE, one or more SRS resource indicators (SRIs) identifying one or more SRS resource sets corresponding to the panel, wherein the one or more SRS resource sets include the one or more SRS resources.

In some aspects, when the UE uses a codebook based transmission scheme, the receiving may further include receiving, at the UE, a medium access control control element (MAC CE) or a downlink control information (DCI) message indicating one or more antenna ports corresponding to the one or more SRS resources.

In some aspects, when the UE uses a non-codebook based transmission scheme, the receiving may further include receiving, at the UE, one or more SRS resource indicators (SRIs) identifying one or more SRS resource sets corresponding to the panel, wherein the one or more SRS resource sets include the one or more SRS resources.

In some aspects, the method may further include receiving, at the UE from the base station, a channel state information reference signal (CSI-RS). The method may further include in response to receiving the CSI-RS, receiving, at the UE, the one or more SRIs identifying the one or more SRS resource sets.

In some aspects, when the UE uses a non-codebook based transmission scheme, the receiving may further include receiving, at the UE, one or more SRS resource indicators (SRIs) identifying the one or more SRS resources corresponding to the panel.

In some aspects, the method may further include receiving the one or more SRIs identifying the one or more SRS resources occurs when a channel state information reference signal (CSI-RS) has not been received from the base station.

In some aspects, a user equipment (UE) may configure PUSCH communications based on identified SRS resources. The UE may comprise one or more panels, a transceiver coupled to the one or more panels, and/or at least one processor coupled to the transceiver. The at least one processor may be configured to receive, from a base station via the transceiver, an indication of whether physical uplink shared channel (PUSCH) communications with the base station are implemented using a codebook based transmission scheme or a non-codebook based transmission scheme. The at least one processor may be configured to receive, from the base station via the transceiver, an indication of one or more sounding reference signal (SRS) resources corresponding to the codebook based transmission scheme or the non-codebook based transmission scheme. The at least one processor may be configured to identify a panel from the one or more panels including one or more antenna ports corresponding to the one or more SRS resources and configure PUSCH transmission communications to use the panel including the one or more antenna ports.

In some aspects, the UE may include a first panel of the one or more panels having a same or different number of antenna ports than a second panel of the one or more panels.

In some aspects, a method for configuring PUSCH communications at a UE may include determining, at the UE, that one or more first panels of the UE are used for transmitting a sounding reference signal (SRS) to a base station and one or more second panels of the UE are used for transmitting physical uplink shared channel (PUSCH) communications to the base station, wherein the one or more first panels differ from the one or more second panels. The method may include applying, at the UE, prioritization scheduling to schedule the PUSCH and SRS communications and switching, at the UE, between the one or more first panels and the one or more second panels according to the prioritization scheduling to communicate with the base station.

In some aspects, applying the prioritization scheduling may further include prioritizing PUSCH communications before SRS communications. In some aspects, applying the prioritization scheduling may further include prioritizing PUSCH communications with uplink control information (UCI) prior to PUSCH communications with data. In some aspects, applying the prioritization scheduling may further include prioritizing aperiodic SRS prior to semi-persistent SRS or periodic SRS.

In some aspects, the method may further include receiving, at the UE, a radio resource control (RRC), a medium access control control element (MAC CE), or a downlink control information (DCI) message from the base station configuring the prioritization scheduling. The method may further include transmitting, from the UE, PUSCH communications to the base station based on the prioritization scheduling.

In some aspects, the method may further include identifying, at the UE, a time delay corresponding to a switch from a first uplink panel to a second uplink panel. The method may further include identifying, at the UE, an uplink signal scheduled for transmission from the UE to the base station within the time delay. The method may further include dropping, at the UE, the uplink signal such that the uplink signal is not transmitted during the time delay.

In some aspects, the method may further include the first and second uplink panels corresponding to a first component carrier (CC) and wherein the uplink signal corresponds to a second CC different from the first CC.

In some aspects, the method may further include identifying, at the UE, a time delay corresponding to a switch from a first uplink panel to a second uplink panel. The method may further include identifying, at the UE, an uplink signal scheduled for transmission from the UE to the base station within the time delay. The method may further include transmitting, from the UE, the uplink signal during the time delay using an antenna supporting simultaneous transmissions across the one or more first panels and the one or more second panels.

In some aspects, the method may further include transmitting, from the UE to the base station, an indication of whether the UE supports simultaneous transmission of uplink signals.

### BRIEF DESCRIPTION OF THE DRAWINGS/FIGURES

FIG. 1A illustrates an example system implementing user equipment (UE) panel selection for physical uplink shared channel (PUSCH) communications, according to some aspects.

FIG. 1B illustrates a block diagram of an example wireless system of an electronic device implementing panel selection for PUSCH communications, according to some aspects.

FIG. 2A illustrates a flowchart for configuring PUSCH communications at a UE, according to some aspects.

FIG. 2B illustrates a flowchart for configuring PUSCH communications at a base station, according to some aspects.

FIG. 3A illustrates a flowchart for configuring codebook PUSCH communications using a list, according to some aspects.

FIG. 3B illustrates a flowchart for configuring codebook PUSCH communications using one or more sounding reference signal (SRS) resources, according to some aspects.

FIG. 3C illustrates a flowchart for configuring codebook PUSCH communications using one or more SRS resource sets, according to some aspects.

FIG. 3D illustrates a flowchart for configuring codebook PUSCH communications using a medium access control control element (MAC CE) or a downlink control information (DCI) message, according to some aspects.

FIG. 4A illustrates a flowchart for configuring non-codebook PUSCH communications using one or more SRS resource sets, according to some aspects.

FIG. 4B illustrates a flowchart for configuring non-codebook PUSCH communications using one or more SRS resources, according to some aspects.

FIG. 4C illustrates a flowchart for configuring non-codebook PUSCH communications based on whether a channel state information reference signal (CSI-RS) is used, according to some aspects.

FIG. 5A illustrates a block diagram of SRS resources corresponding to different panels, according to some aspects.

FIG. 5B illustrates a block diagram of SRS resource sets corresponding to different panels, according to some aspects.

FIG. 6 illustrates a flowchart for applying prioritization scheduling at a UE using different panels for SRS and PUSCH communications, according to some aspects.

FIG. 7 illustrates a block diagram of uplink signal dropping during panel switching, according to some aspects.

FIG. 8 depicts an example computer system useful for implementing various aspects.

The features and advantages of the aspects will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various aspects. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B).

This disclosure relates to user equipment (UE) communications using the various wireless communications protocols developed by the 3rd Generation Partnership Project (3GPP), including Release 15 (Rel-15), Release 16 (Rel-16), Release 17 (Rel-17), or others, of which one or more are related to the 5G wireless protocol standard (e.g., 5G).

As developments continue with subsequent releases of the 5G standard and beyond, one consideration that remains is how to select an antenna panel (herein “panel”) at a UE to use for sounding reference signal (SRS) and/or physical uplink shared channel (PUSCH) communications. Some UE's may include multiple panels. In some aspects, UEs may include 3 or 4 panels. The panels may correspond to different groups of antenna ports on the UE. The panels may have different sizes and/or support different numbers of beams. For example, panels may have different dimensions of antenna elements, such as, 1×4, 2×2, and/or 1×2. The panel size may vary based on space limitations at the UE. UEs may use one or more panels to communicate with a base station (BS) via uplink or downlink. In some aspects, the BS may be a 5G Node B (gNB).

Because different panels on a UE may have different numbers of ports, selecting a particular panel for communications may be complicated. For example, there may be a time delay when selecting a panel or switching to another panel. This time delay may differ when different panels have different activation or deactivation statuses. These considerations for panel switching and/or panel selection may be particularly relevant for PUSCH communications.

PUSCH transmissions from a UE may also include an additional layer of complexity when determining whether the UE uses a codebook (CB) or non-codebook (NCB) transmission scheme. In a CB scheme, one or more codebooks may be predefined. Different codebooks may be used for different ports. For the UE to provide PUSCH communications, a BS may indicate a precoder using a sounding reference signal (SRS) resource indicator (SRI), transmission rank indicator (TRI), and/or a transmission precoder matrix indicator (TPMI). The SRI may indicate a number of antenna ports to use for PUSCH communications. The UE may use this information to select a codebook. The TRI and/or the TPMI may be used to identify a precoder from the selected codebook.

In some aspects, UEs may use a NCB transmission scheme for PUSCH communications. In this case, the UE may transmit one or more precoded SRS resources to the BS. The UE may have derived the precoder used for this SRS based on an associated channel state information reference signal (CSI-RS) configured by and/or transmitted from the BS. The CSI-RS may be a downlink signal received by UE 110 and used to estimate the channel quality. The NCB precoder may be derived from this CSI-RS signal. In some aspects, the BS may provide an indication of one or more SRS resources to the UE via one or more SRIs. After receiving the one or more SRIs at the UE, the UE may transmit PUSCH communications using the precoder corresponding to the indicated SRS resources.

Additionally complexities for PUSCH communications may occur based on whether the communication system uses a dynamic-grant (DG) based PUSCH or a configured-grant (CG) based PUSCH. For DG PUSCH communications, SRI, TRI, and/or TPMI messages may be indicated to a UE from a BS by a scheduling downlink control information (DCI) message. For CG PUSCH communications, SRI, TRI, and/or TPMI messages may be indicated to a UE from a BS by a radio resource control (RRC) message. In some aspects, additional complexity may occur when a UE is able to transmit a SRS to the BS for CB, NCB, and/or PUSCH communications using different component carriers (CCs).

This disclosure addresses these complexities and describes aspects for selecting one or more panels to use for SRS and/or PUSCH communications. This determination may be based on SRS resources configured by a base station. The base station may provide one or more SRIs to the UE to configure SRS resources. The UE may then identify a particular panel for PUSCH communications as well based on the corresponding SRS resources.

For example, for CB based PUSCH transmission schemes, different numbers of ports may be configured for different SRS resources. For NCB based PUSCH transmission schemes, different SRS resources or resource sets may associated with a panel. To address communications using different CCs, the UE may be limited to using one panel to transmit signals. In some aspects, the UE may report a panel selection with a reference signal used for beam indication. This reference signal may be configured using a received transmission configuration indication (TCI) or spatial relation information configured for a SRS. In some aspects, if the reference signal is a downlink signal such as a synchronization signal block (SSB) or a CSI-RS, the UE may report a selected panel associated with the reference signal in a beam report. In some aspects, if the reference signal is an uplink reference signal, such as a SRS, the UE may have a predefined panel selection and/or the UE may report the panel selection.

As will be further explained below, to manage the potential situations arising from panel selection at the UE, communications with a BS may be configured using a particular SRS resource configuration. The BS may provide the UE with this configuration for the UE to select a particular panel for PUSCH communications. For CB based transmission schemes, the BS may provide an SRI, TRI, and/or TPMI indication to the UE for selecting a panel. For NCB based transmission schemes, the BS may provide an SRI indication to the UE for selecting a panel. The UE may also manage simultaneous transmission for SRS and PUSCH communications with different panels in different component carriers (CCs).

When using these configurations, the UE and/or BS may communicate in a more synchronized manner. Using SRS and/or SRI signaling may provide a flexible way for a BS to indicate a particular panel for use at the UE to perform SRS and/or PUSCH communications. The configurations described herein may provide additional flexibility to wireless communications networks supporting different UEs with different panel configurations and/or capabilities.

Various aspects of these features will now be discussed with respect to the corresponding figures.

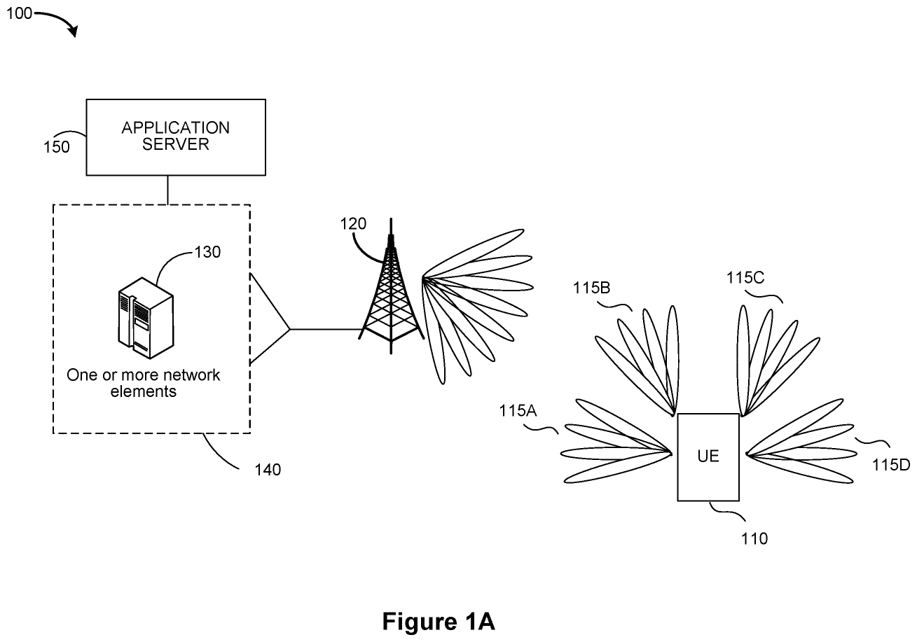

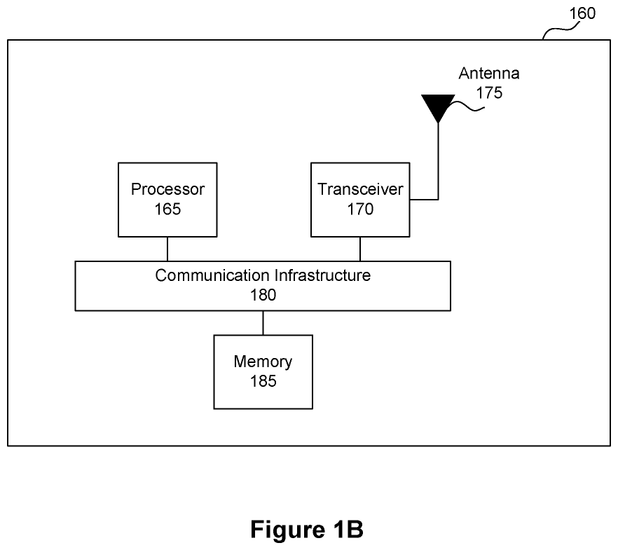

FIG. 1A illustrates an example system 100 implementing user equipment (UE) panel selection for physical uplink shared channel (PUSCH) communications, according to some aspects. FIG. 1A illustrates an example system architecture of a network, in accordance with various aspects. The following description is provided for an example system 100 that operates in conjunction with 5G or NR system standards as provided by 3GPP technical specifications. However, the example aspects are not limited in this regard and the described aspects may apply to other networks that benefit from the principles described herein, such as other 3GPP systems (e.g., Sixth Generation (6G)) systems, IEEE 802.16 protocols (e.g., WMAN, WiMAX, etc.), or the like.

As shown by FIG. 1A, the system 100 includes UE 110. In this example, UE 110 is illustrated as a smartphone (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, personal digital assistants (PDAs), pagers, wireless handsets, and the like. UE 110 may include one or more panels.

UE 110 may be configured to connect, for example, communicatively coupled, with a Radio Access Network (RAN) including a base station 120. Base station 120 may be a RAN node. Base station 120 may also be referred to as a RAN node or 5G Node B (gNB). In aspects, the RAN may be an NG RAN or a 5G RAN, an E-UTRAN, or a legacy RAN, such as a UTRAN or GERAN. As used herein, the terms “NR RAN” or “NG RAN” or “next-generation RAN” or the like may refer to a RAN that operates in an NR or 5G system 100, and the term “E-UTRAN” or the like may refer to a RAN that operates in an LTE or 4G system 100. The UE 110 may utilize connections (or channels), each of which comprises a physical communications interface or layer (discussed in further detail below). In some aspects, UE 110 may communicate with one or more base stations 120.

Base station 120 is shown to be communicatively coupled to a core network—in this aspect, core network (CN) 140. The CN 140 may comprise a plurality of network elements 130, which are configured to offer various data and telecommunications services to customers/subscribers (e.g., a user of UE 110) who are connected to the CN 140 via base station 120.

Generally, the application server 150 may be an element offering applications that use IP bearer resources with the core network (e.g., UMTS PS domain, LTE PS data services, etc.). The application server 150 can also be configured to support one or more communication services (e.g., VoIP sessions, PTT sessions, group communication sessions, social networking services, etc.) for the UE 110 via the CN 140.

In some aspects, UE 110 may include one or more panels. Each panel may include one or more antenna ports. As previously explained, each panel may also include different configurations and/or sizes. In some aspects, the panels may be configured to communicate with base station 120 using beams 115A, 115B, 115C, and/or 115D. Each set of beams 115 may correspond to a different panel of UE 110. As will be further explained below, UE 110 may determine a particular panel to use for PUSCH communications. The selected panel may communicate with base station 120 using its associated set of beams 115.

Beams 115 may also be used to communicate SRS communications to base station 120. A particular panel for these communications may also be selected and used for SRS communications. A SRS may be an uplink signal transmitted by UE 110 to aid base station 120 in obtaining channel stat information (CSI) for UE 110. This CSI may describe how signals are propagated from UE 110 to base station 120. This may reflect the combined effects of scattering, fading, and/or power decay with distance. In some aspects, UE 110 may be configured to provide SRS communications with base station 120 based on received SRI messages. The SRI messages received from base station 120 may configure UE 110 to transmit SRS signals. Similarly, as will be further described below, the received SRI messages may be used to select a panel for PUSCH communications.

FIG. 1B illustrates a block diagram of an example wireless system 160 of an electronic device implementing panel selection for PUSCH communications, according to some aspects. As a convenience and not a limitation, system 160, may be described with elements of FIG. 1A. System 160 may be UE 110 or base station 120 of FIG. 1A. System 160 may include processor 165, transceiver 170, communication infrastructure 180, memory 185, and antenna 175 that together facilitate panel selection. Transceiver 170 transmits and receives wireless communications signals, such as 5G wireless communications signals via antenna 175. Communication infrastructure 180 may be a bus. Memory 185 may include random access memory (RAM) and/or cache, and may include control logic (e.g., computer software), computer instructions, and/or data. Processer 165, upon execution of the computer instructions, may be configured to perform the functionality described herein for panel selection. Alternatively, processor 165 can include its own internal memory (not shown), and/or be “hard-wired” (as in a state-machine) configured to perform the functionality described herein for panel selection.

Antenna 175 coupled to transceiver 170, may include one or more antennas, antenna arrays, and/or panels that may be the same or different types to enable wireless communication over a wireless network. As previously described, the panels may include different configurations of antenna ports. In some aspects, a first panel of UE 110 may have a different number of antenna ports than a second panel of UE 110. In some aspects, a first panel of UE 110 may have the same number of antenna ports as a second panel of the UE. As previously described, in some aspects, UE 110 may include three, four, or a plurality of panels. These panels may have the same number of antenna ports, a different number of antenna ports, and/or a combination of same and different number of antenna ports. Similarly, the configuration of the antenna ports for the panels may be the same, different, and/or a combination of same and different.

In some aspects, UE 110 may utilize the components of wireless system 160. According to some aspects, processor 165, alone or in combination with memory 185, and/or transceiver 170, may implement the panel selection. In some aspects, UE 110 may be configured to use one or more of the processes described below to select a particular panel. UE 110 may stored instructions in memory 185. Once executed by processor 165, processor 165 may identify one or more panels to use for PUSCH communications. In some aspects, UE 110 may be preset or pre-configured to perform the panel selection. In some aspects, UE 110 may communicate with a base station 120 to receive instructions and/or data for selecting a panel. This panel selection may also be performed when UE 110 is using a CB or NCB based transmission scheme. In some aspects, UE 110 may support SRS and PUSCH transmissions associated with different panels. As further explained below, UE 110 may be configured to avoid signal collisions in this case.

In some aspects, as further explained below, UE 110 may transmit SRS signals and/or receive SRI messages via antenna 175 and/or transceiver 170. This transmission and/or reception may depend on a selected panel corresponding to antenna 175. As will be further explained below, base station 120 may configure UE 110 based on SRS resource allocation and/or using SRI messages.

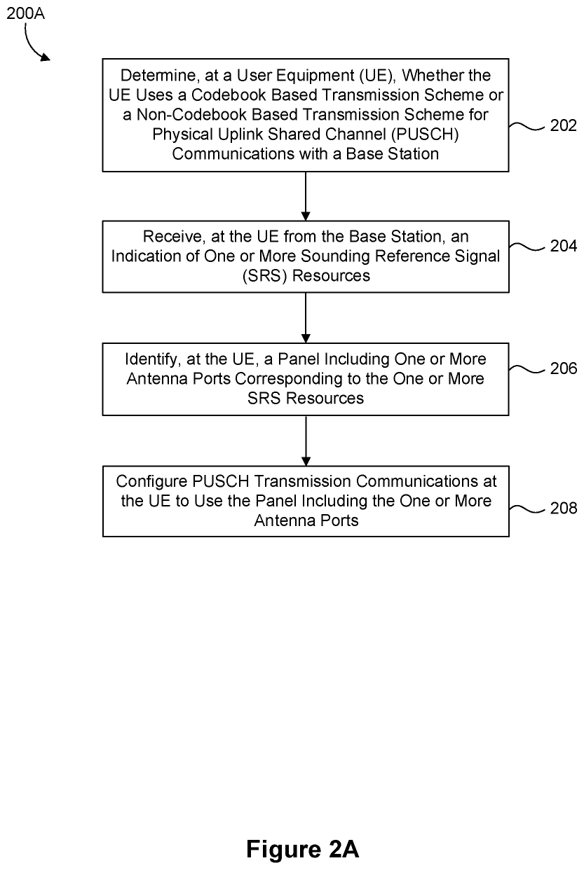

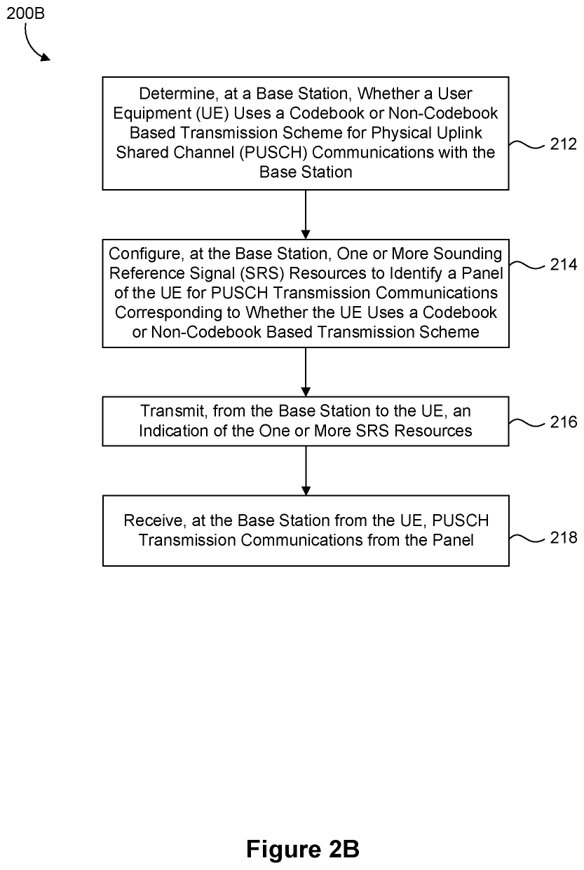

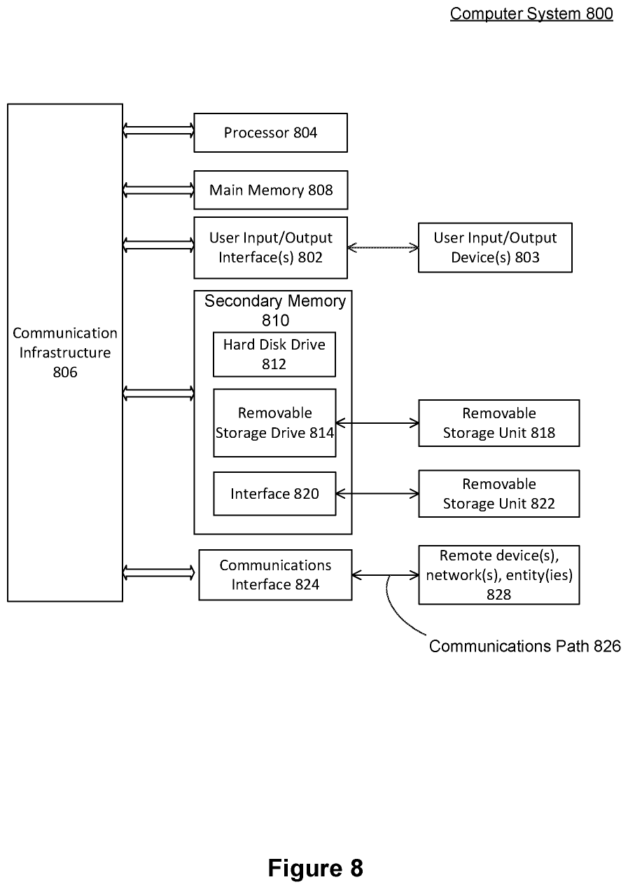

FIG. 2A illustrates a flowchart 200A for configuring PUSCH communications at a UE, according to some aspects. In some aspects, UE 110 may execute flowchart 200A. Flowchart 200A shall be described with reference to UE 110; however, flowchart 200A is not limited to that example aspect. Flowchart 200A may be implemented by processor 165 (FIG. 1B). For example, processor 165 may execute instructions, stored in memory 185, to perform the functions described in flowchart 200A. Alternatively, processor 165 may be “hard-coded” to perform these functions. Additionally, flowchart 200A may be executed on any computing device, such as, for example, the computer system described with reference to FIG. 8 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 2A, as will be understood by a person of ordinary skill in the art.

At 202, UE 110 may determine whether the UE 110 uses a codebook (CB) based transmissions scheme or a non-codebook (NCB) based transmission scheme for physical uplink shared channel (PUSCH) communications with a base station 120. In some aspects, UE 110 may receive an indication from base station 120 indicating whether to use a CB based transmission scheme or a NCB based transmission scheme. As previously explained, base station 120 may be a RAN node and/or a gNB. UE 110 may include one or more panels. As further explained below, a selection from the one or more panels may be performed depending on whether the UE uses a CB or NCB transmission scheme. The distinction may determine how the UE identifies a precoder to use for PUSCH transmissions.

For example, for a CB scheme, UE 110 may manage a set of codebooks, which may be predefined. Each codebook may correspond to different ports or number of ports. Base station 120 may indicate a precoder for the CB scheme. UE 110 may use this precoder for PUSCH communications. As previously explained, base station 120 may transmit an SRI, TRI, and/or TPMI to UE 110 to indicate the precoder. The SRI may indicate one or more antenna ports, which may be used by UE 110 to select a codebook. The TRI and/or TPMI may be used to identify a precoder from the selected codebook.

For a NCB scheme, UE 110 may transmit a precoded SRS resource to the base station 120. The precoder used for this precoded SRS resource may be derived based on a corresponding CSI-RS configured by base station 120. Base station 120 may then identify one or more SRS resources at the UE 110 using one or more SRI messages transmitted to UE 110. UE 110 may then transmit PUSCH communications based on the precoder corresponding to the SRS resources identified in the SRI messages.

In some aspects, UE 110 may be pre-configured to use a CB or NCB scheme prior to establishing communications with base station 120. As further described below, the determination of whether a CB or NCB transmission scheme is used may alter the process for configuring UE 110 to select a particular panel for PUSCH transmissions.

At 204, UE 110 may receive, from base station 120, an indication of one or more SRS resources. For example, for a CB based transmission scheme, UE 110 may receive a list identifying one or more one or more antenna ports to use for SRS resources. In some aspects, UE 110 may receive one or more SRI messages. The one or more SRI messages may identify SRS resources and/or sets of SRS resources. In some aspects, base station 120 may update a number of antenna ports for each SRS resource or resource set using a medium access control control element (MAC CE) or a downlink control information (DCI) message. For NCB based transmissions, each SRS resource may correspond to a particular port. For example, each SRS resource may correspond to a single port. Base station 120 may configure SRS resources and/or provide an SRI indication identifying SRS resources and/or sets of SRS resources. This indication may identify SRS resources and/or SRS resource sets corresponding to the same panel used for PUSCH transmissions. With this association, UE 110 may identify a panel for PUSCH transmissions.

At 206, UE 110 may identify a panel including one or more antenna ports corresponding to the one or more SRS resources. As previously explained, the one or more SRS resources identified by base station 120 may or may not be grouped into sets. The SRS resources identified by base station 120 may provide an indication of the particular panel to use for PUSCH transmissions at UE 110. The panel selected may include the one or more antenna ports identified corresponding to the one or more SRS resources.

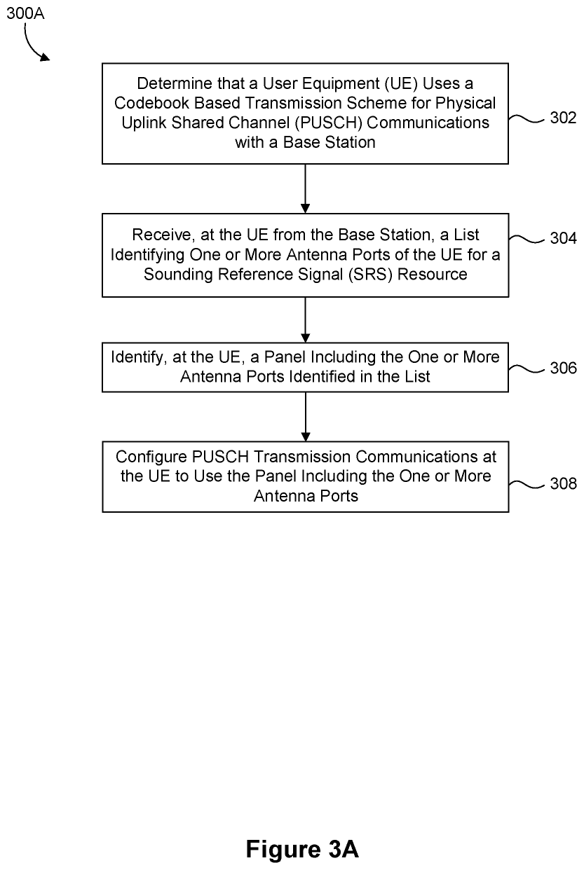

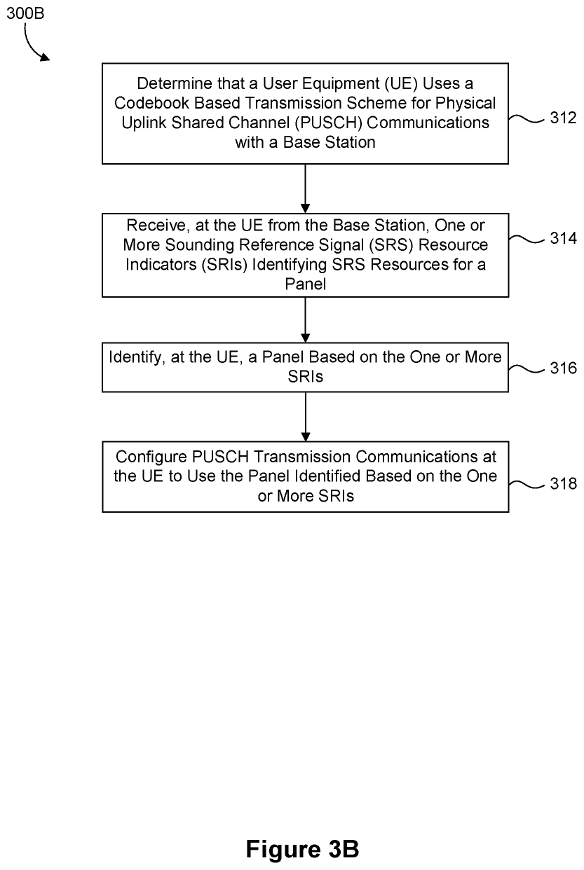

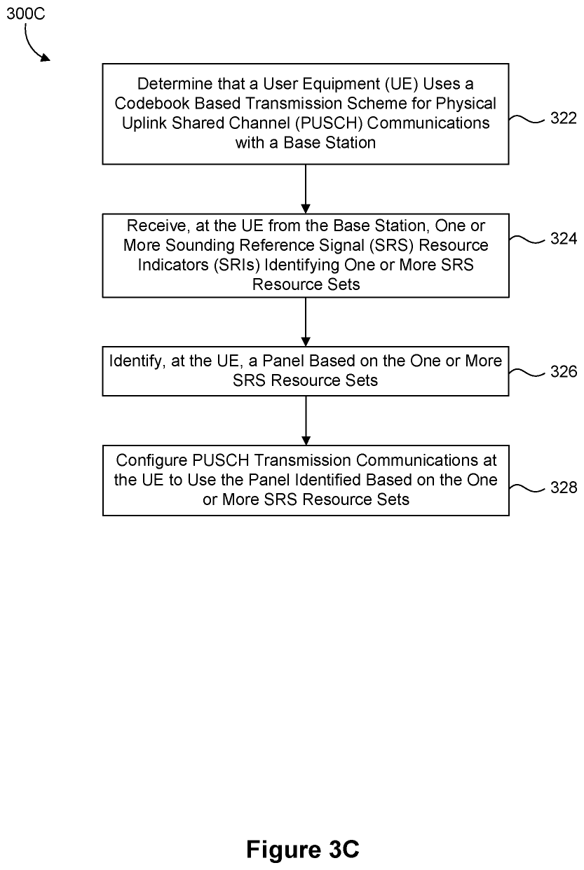

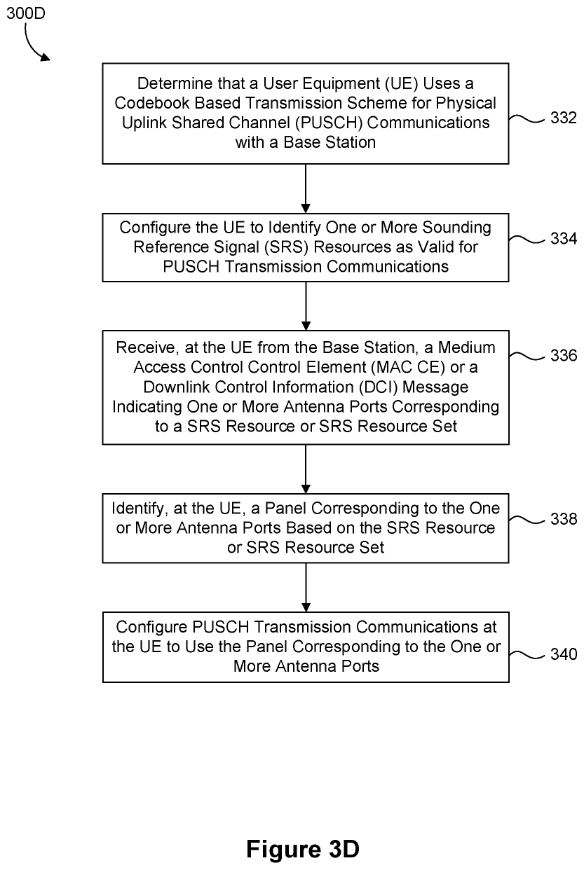

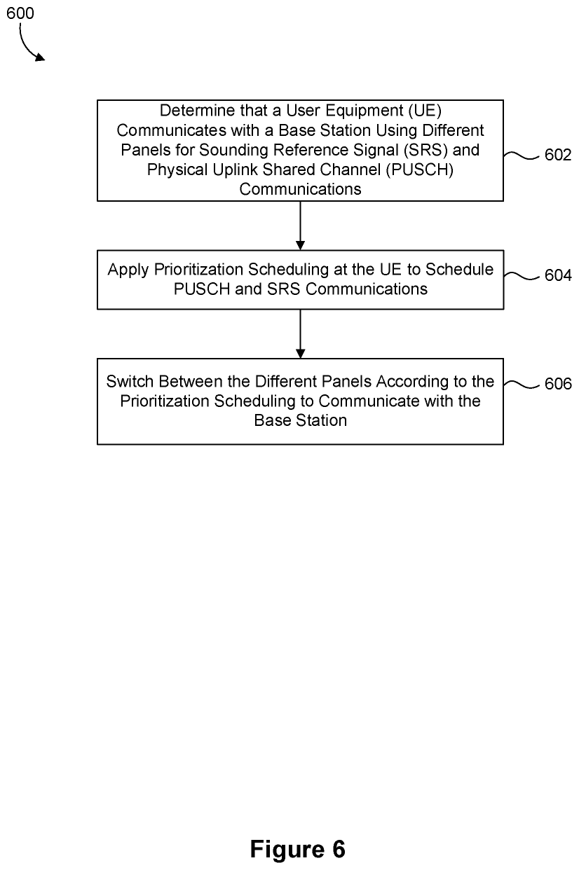

At 208, UE 110 may configure PUSCH transmission communications to use the panel including the one or more antenna ports. In some aspects, UE 110 may configure one or more antenna beams on the identified panel for the PUSCH transmissions. The antenna beams may correspond to the one or more antenna ports. In this manner, UE 110 may use the panel to perform SRS and/or PUSCH transmissions. By configuring the SRS resources at base station 120 and providing this indication to UE 110, UE 110 may identify a corresponding panel for PUSCH transmissions. As will be further explained below, this may be applicable in CB and/or NCB transmission schemes. FIGS. 3A-3D, 4A-4C, and 5A-5B address these scenarios. FIG. 6 addresses the scenario where SRS and PUSCH transmissions are associated with different panels across component carriers (CCs). In this case, SRS and PUSCH transmissions may occur simultaneously.

FIG. 2B illustrates a flowchart 200B for configuring PUSCH communications at a base station 120, according to some aspects. In some aspects, base station 120 may execute flowchart 200B. Flowchart 200B shall be described with reference to base station 120; however, flowchart 200B is not limited to that example aspect. Flowchart 200B may be implemented by processor 165 (FIG. 1B). For example, processor 165 may execute instructions, stored in memory 185, to perform the functions described in flowchart 200B. Alternatively, processor 165 may be “hard-coded” to perform these functions. Additionally, flowchart 200B may be executed on any computing device, such as, for example, the computer system described with reference to FIG. 8 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 2B, as will be understood by a person of ordinary skill in the art.

At 212, base station 120 may determine whether the UE 110 uses a codebook (CB) or non-codebook (NCB) based transmission scheme for physical uplink shared channel (PUSCH) communications with base station 120. This may occur similar to 202 as described with reference to FIG. 2A. In some aspects, base station 120 may be pre-configured to identify UE 110 as using a CB or NCB scheme. In some aspects, base station 120 may exchange messages with UE 110 to determine whether a CB or NCB scheme is used. For example, base station 120 may transmit an indication to UE 110 that configures UE 110 to use a CB or NCB transmission scheme.

At 214, base station 120 may configured one or more SRS resources to identify a panel of the UE 110 for PUSCH transmission communications corresponding to whether UE 110 uses a CB or NCB based transmission scheme. As will be further explained with reference to FIGS. 3A-3D, 4A-4C, and 5A-5B, base station 120 may configure one or more SRS resources and/or SRS resource sets to indicate a panel for UE 110 to use for PUSCH transmissions. In some aspects, the one or more SRS resources may correspond to one or more antenna ports on UE 110. UE 110 may identify these corresponding antenna ports and identify a panel corresponding to the identified SRS resources.

At 216, base station 120 may transmit to UE 110 an indication of the one or more SRS resources. In some aspects, this indication may be a list indicating one or more antenna ports. In some aspects, this indication may be an SRI, TRI, and/or TPMI. After UE 110 receives this indication, UE 110 may identify a panel to use for PUSCH communications. At 218, base station 120 may receive PUSCH transmission communications from UE 110 via the identified panel.

FIG. 3A illustrates a flowchart 300A for configuring codebook PUSCH communications using a list, according to some aspects. In some aspects, UE 110 may execute flowchart 300A. Flowchart 300A shall be described with reference to UE 110; however, flowchart 300A is not limited to that example aspect. Flowchart 300A may be implemented by processor 165 (FIG. 1B). For example, processor 165 may execute instructions, stored in memory 185, to perform the functions described in flowchart 300A. Alternatively, processor 165 may be “hard-coded” to perform these functions. Additionally, flowchart 300A may be executed on any computing device, such as, for example, the computer system described with reference to FIG. 8 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3A, as will be understood by a person of ordinary skill in the art.

At 302, UE 110 may determine that the UE 110 uses a codebook (CB) based transmission scheme for physical uplink shared channel (PUSCH) communications with a base station 120. This may occur in a manner similar to 202. For example, base station 120 may transmit an indication to UE 110 configuring UE 110 to use a CB based transmission scheme. In some aspects, UE 110 may be pre-configured to use a CB scheme for PUSCH communications. For example, instructions and/or codebooks may be stored in memory of UE 110. The codebooks may be used to identify a precoder for PUSCH communications.

At 304, UE 110 may receive, from base station 120, a list identifying one or more antenna ports of UE 110 for a sounding reference signal (SRS) resource. This list may be received by UE 110 to be used for CB based PUSCH transmissions. This list may address the situation where different panels on UE 110 have different numbers of antenna ports. The list may identify one or more antenna ports corresponding to each of the panels on UE 110. Different codebooks may correspond to these different numbers of antenna ports. The list may identify one or more antenna ports to support precoder selection from the different codebooks. In this manner, base station 120 may provide a list identifying a number of antenna ports. In some aspects, the list may identify specific antenna ports using port index numbers. In some aspects, the list may identify a number or quantity of antenna ports. Base station 120 may identify the particular antenna ports on the list based on their association with a particular panel for SRS and/or PUSCH communications. In some aspects, the panel identification at the base station 120 may be based on spatial relation information corresponding to SRS and/or PUSCH communications. In some aspects, base station 120 may provide the list to UE 110 using a transmission configuration indication (TCI) message.

At 306, UE 110 may identify a panel including the one or more antenna ports identified in the list. By identifying the antenna ports, UE 110 may also identify the associated panel. The selection of the particular panel may depend on the SRS resource configured by the base station 120. In some aspects, the list may include an update to the identification of one or more antenna ports for one or more SRS resources.

At 308, UE 110 may configure PUSCH transmission communications to use the panel including the one or more antenna ports. In this manner, base station 120 may identify one or more SRS resources for the UE 110 in order to configure UE 110 to supply PUSCH transmissions using the same panel as SRS transmissions. The list provided by base station 120 may configure SRS and/or PUSCH transmissions from UE 110. By configuring the PUSCH communications in this manner, panel switching delays may be avoided. Avoiding these delays may be particularly relevant when different panels have different numbers of antenna ports.

FIG. 3B illustrates a flowchart 300B for configuring codebook PUSCH communications using one or more sounding reference signal (SRS) resources, according to some aspects. In some aspects, UE 110 may execute flowchart 300B. Flowchart 300B shall be described with reference to UE 110; however, flowchart 300B is not limited to that example aspect. Flowchart 300B may be implemented by processor 165 (FIG. 1B). For example, processor 165 may execute instructions, stored in memory 185, to perform the functions described in flowchart 300B. Alternatively, processor 165 may be “hard-coded” to perform these functions. Additionally, flowchart 300B may be executed on any computing device, such as, for example, the computer system described with reference to FIG. 8 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3B, as will be understood by a person of ordinary skill in the art.

At 312, UE 110 may determine that the UE 110 uses a codebook (CB) based transmission scheme for physical uplink shared channel (PUSCH) communications with a base station 120. This may occur in a manner similar to 202. For example, base station 120 may transmit an indication to UE 110 configuring UE 110 to use a CB based transmission scheme. In some aspects, UE 110 may be pre-configured to use a CB scheme for PUSCH communications. For example, instructions and/or codebooks may be stored in memory of UE 110. The codebooks may be used to identify a precoder for PUSCH communications.

At 314, UE 110 may receive, from base station 120, one or more sounding reference signal (SRS) resource indicators (SRIs) identifying SRS resources for a panel. In some aspects, UE 110 may have different SRS resources associated with different panels. Base station 120 may identify a particular panel by sending SRIs corresponding to SRS resources for that particular panel. The particular panel may be selected as the one having a greater number of SRS resources relative to other panels. For example, valid SRS resources may correspond to a panel having a number of antenna ports capable of supporting a quantity of valid SRS resources. In some aspects, a maximum number of antenna ports on a panel may be considered. Valid SRS resources may be equal to or less than this maximum number. Upon identifying valid SRS resources, base station 120 may transmit an SRI indicating the valid SRS resources. In some aspects, base station 120 may transmit one or more SRI messages for each SRS resource at UE while additionally indicating SRS resources that are valid for panel selection. In some aspects, base station may transmit only the SRIs associated with valid SRS resources.

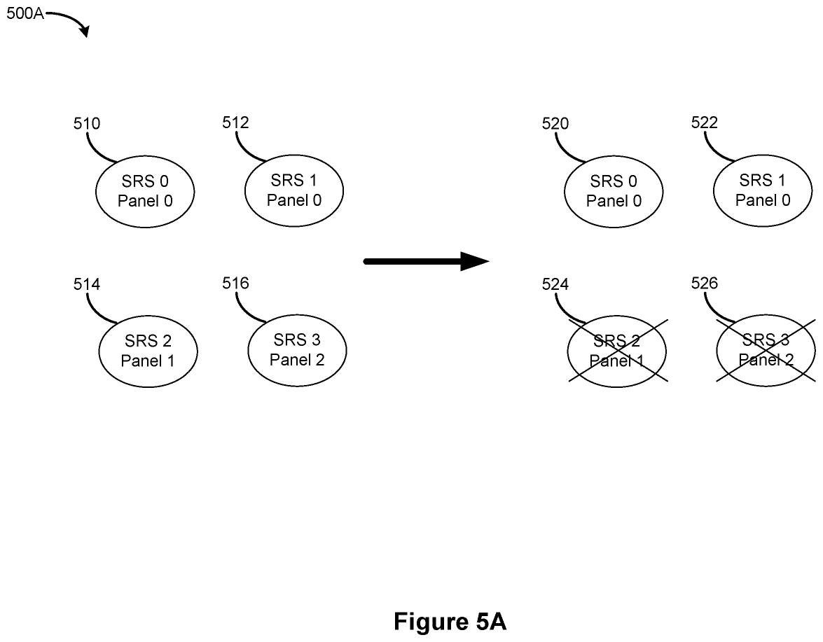

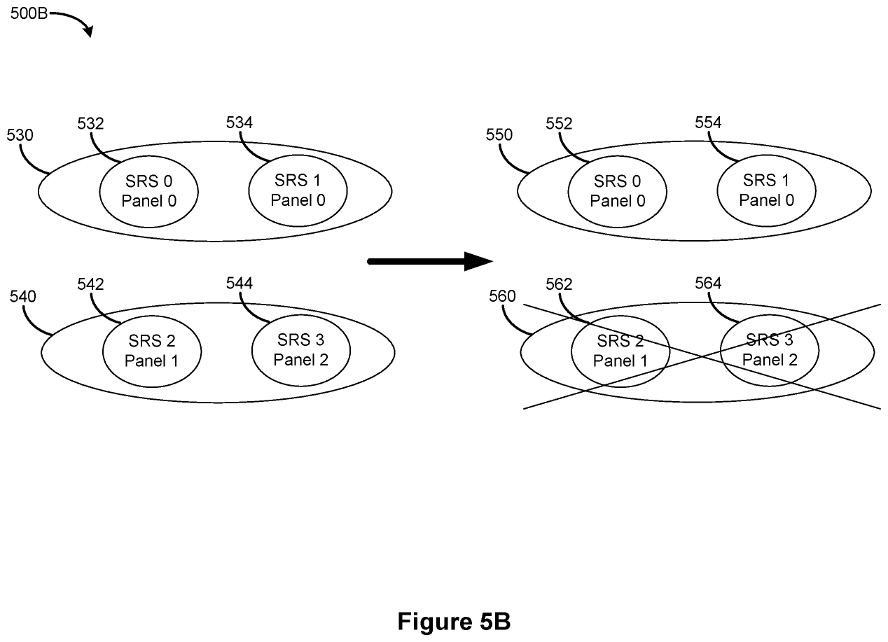

FIG. 5A provides an example of this SRI transmission. FIG. 5A illustrates a block diagram 500A of SRS resources 510-526 corresponding to different panels, according to some aspects. For example, UE 110 may be configured with three panels (Panels 0, 1, and 2) with associated SRS resources 510, 512, 514, 516. A first SRS resource 510 (SRS 0) and a second SRS resource 512 (SRS 1) may correspond to Panel 0. A third SRS resource 514 may correspond to Panel 1 while a fourth SRS resource 516 may correspond to Panel 2.

Based on this configuration, base station 120 may determine that Panel 0 should be used for SRS and/or PUSCH communications. This determination may be based on the number of antenna ports corresponding to Panel 0. This number of antenna ports may be capable of supporting SRS and/or PUSCH communications. In this manner, base station 120 may transmit to UE 110 one or more SRI messages indicating that the first SRS resource 520 and the second SRS resource 522 are valid for use in selecting a panel. UE 110 may then recognize that these SRS resources 520, 522 correspond to Panel 0. UE 110 may then be configured to use Panel 0 for SRS and/or PUSCH communications. In some aspects, UE 110 may recognize the third and fourth SRS resources 524, 526 as invalid SRS resources.

As previously explained, in some aspects, base station 120 may indicate valid SRS resources as well as invalid SRS resources to UE 110. In some aspects, base station 120 may only transmit SRIs associated with valid SRS resources.

At 316, UE 110 may identify a panel based on the one or more SRIs. As previously explained, the panel may correspond to the identified valid SRS resources. At 318, UE 110 may configure PUSCH transmission communications to use the panel identified based on the one or more SRIs.

FIG. 3C illustrates a flowchart 300C for configuring codebook PUSCH communications using one or more SRS resource sets, according to some aspects. In some aspects, UE 110 may execute flowchart 300C. Flowchart 300C shall be described with reference to UE 110; however, flowchart 300C is not limited to that example aspect. Flowchart 300C may be implemented by processor 165 (FIG. 1B). For example, processor 165 may execute instructions, stored in memory 185, to perform the functions described in flowchart 300C. Alternatively, processor 165 may be “hard-coded” to perform these functions. Additionally, flowchart 300C may be executed on any computing device, such as, for example, the computer system described with reference to FIG. 8 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3C, as will be understood by a person of ordinary skill in the art.

At 322, UE 110 may determine that the UE 110 uses a codebook (CB) based transmission scheme for physical uplink shared channel (PUSCH) communications with a base station 120. This may occur in a manner similar to 202. For example, base station 120 may transmit an indication to UE 110 configuring UE 110 to use a CB based transmission scheme. In some aspects, UE 110 may be pre-configured to use a CB scheme for PUSCH communications. For example, instructions and/or codebooks may be stored in memory of UE 110. The codebooks may be used to identify a precoder for PUSCH communications.

At 324, UE 110 may receive, from base station 120, one or more sounding reference signal (SRS) resource indicators (SRIs) identifying one or more SRS resource sets. In some aspects, base station 120 may configure one or more SRS resource sets to group SRS resources into sets. SRS resources within a set may correspond to the same number of antenna ports. SRS resources between sets, however, may be configured with a different number of antenna ports. In some aspects, each resource set may correspond to a different panel on the UE. In this manner, the number of antenna ports corresponding to a set may correspond to the number of antenna ports supported by a particular panel. Similar to 314, base station 120 may identify a set of SRS resources that are valid for PUSCH communications. The identified SRS resource set may correspond to the same panel used for PUSCH communications. Base station 120 may transmit an indication of this valid SRS resource set to UE 110. This indication may be one or more SRI messages.

FIG. 5B provides an example of this SRI transmission. FIG. 5B illustrates a block diagram 500B of SRS resource sets 530, 540 corresponding to different panels, according to some aspects. SRS resource set 530 may include SRS resources 532, 534. A first SRS resource 532 (SRS 0) and a second SRS resource 534 (SRS 1) may correspond to Panel 0. SRS resource set 540 may include SRS resources 542, 544. A third SRS resource 542 may correspond to Panel 1 while a fourth SRS resource 544 may correspond to Panel 2.

Based on this configuration, base station 120 may determine that Panel 0 should be used for SRS and/or PUSCH communications. Base station 120 may transmit an SRI to UE 110 identifying SRS resource set 530 for SRS and/or PUSCH communications. In some aspects, the SRI may identify an SRI set index number such as “SRS set 0” corresponding to SRS resource set 530.

UE 110 may then recognize SRS resource set 550 as valid and corresponding to Panel 0. SRS resource set 550 may include valid SRS resources 552, 554, which may correspond to Panel 0. In some aspects, UE 110 may recognize SRS resource set 560 as including invalid SRS resources 562, 564. UE 110 may then recognize third and fourth SRS resources 562, 564 as invalid SRS resources. In some aspects, base station 120 may indicate valid SRS resource sets as well as invalid SRS resource sets to UE 110. In some aspects, base station 120 may only transmit SRIs associated with valid SRS resource sets.

At 326, UE 110 may identify a panel based on the one or more SRS resource sets. UE 110 may identify the panel based on the received one or more SRIs. As previously explained, the panel may correspond to the identified valid SRS resource set. At 328, UE 110 may configure PUSCH transmission communications to use the panel identified based on the one or more SRS resource sets.

FIG. 3D illustrates a flowchart 300D for configuring codebook PUSCH communications using a medium access control control element (MAC CE) or a downlink control information (DCI) message, according to some aspects. In some aspects, UE 110 may execute flowchart 300D. Flowchart 300D shall be described with reference to UE 110; however, flowchart 300D is not limited to that example aspect. Flowchart 300D may be implemented by processor 165 (FIG. 1B). For example, processor 165 may execute instructions, stored in memory 185, to perform the functions described in flowchart 300D. Alternatively, processor 165 may be “hard-coded” to perform these functions. Additionally, flowchart 300D may be executed on any computing device, such as, for example, the computer system described with reference to FIG. 8 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3D, as will be understood by a person of ordinary skill in the art.

At 332, UE 110 may determine that the UE 110 uses a codebook (CB) based transmission scheme for physical uplink shared channel (PUSCH) communications with a base station 120. This may occur in a manner similar to 202. For example, base station 120 may transmit an indication to UE 110 configuring UE 110 to use a CB based transmission scheme. In some aspects, UE 110 may be pre-configured to use a CB scheme for PUSCH communications. For example, instructions and/or codebooks may be stored in memory of UE 110. The codebooks may be used to identify a precoder for PUSCH communications.

At 334, UE 110 may configure UE 110 to identify one or more SRS resources as valid for PUSCH transmissions communications. For example, UE 110 may be pre-configured to assume that a set of SRS resources are valid for PUSCH communications. In some aspects, UE 110 may consider all configured SRS resources to be valid. As further described below, base station 120 may update the number of antenna ports for each SRS resource and/or SRS resource set. This updating may indicate the panel to use for PUSCH communications.

At 336, UE 110 may receive from base station 120, a MAC CE or a DCI indicating one or more antenna ports corresponding to a SRS resource or a SRS resource set. The MAC CE or DCI may update the antenna ports corresponding to each SRS resource and/or SRS resource set. This may be layer 1 or layer 2 signaling to update the antenna ports at UE 110. In some aspects, this updating may be based on the UE 110 configuration assuming that all configured SRS resources are valid. In some aspects, base station 120 may update the number of antenna ports for a SRS resource when a new panel with a different number of antenna ports is selected. Base station 120 may transmit the MAC CE or the DCI separately or associated with a TCI and/or with spatial relation update signaling.

In some aspects, when the MAC CE or DCI are used for a TCI update, the number of antenna ports for one or more SRS resources for the CB PUSCH transmissions may be indicated. For example, one or more fields of the MAC CE or DCI may be used. In some aspects, the MAC CE or DCI may update the antenna ports for all or a subset of SRS resources at UE 110.

In some aspects, the number of antenna ports may be automatically updated based on a beam report. For example, UE 110 may report a panel used to provide a beam or reference signal to base station 120. Base station 120 may use this beam or reference signal to generate and/provide the TCI and/or spatial relation information used for SRS signaling. Based on the beam reporting provided by UE 110, base station 120 may recognize that the number of ports for the SRS resources should be updated. This update may occur based on a number of antenna ports for the panel identified by UE 110. In some aspects, the update may be based on a maximum number of antenna ports on the panel.

At 338, UE 110 may identify a panel corresponding to the one or more antenna ports based on the SRS resource or SRS resource sets. UE 110 may update the antenna ports on the panel based on the MAC CE or DCI. UE 110 may update the antenna ports on the selected panel previously reported to base station 120. At 340, UE 110 may configure PUSCH transmission communications to use the panel corresponding to the one or more antenna ports. UE 110 may use the updated antenna ports identified by the MAC CE or DCI.

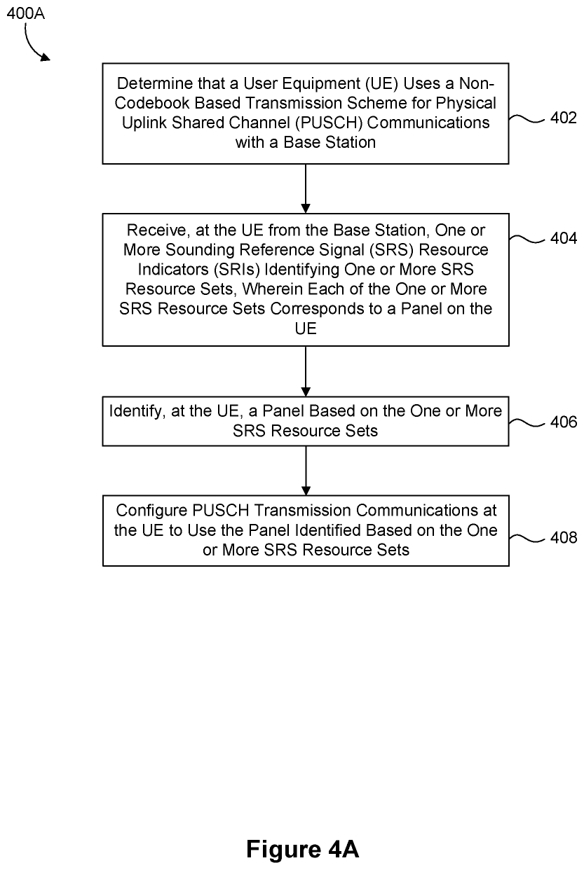

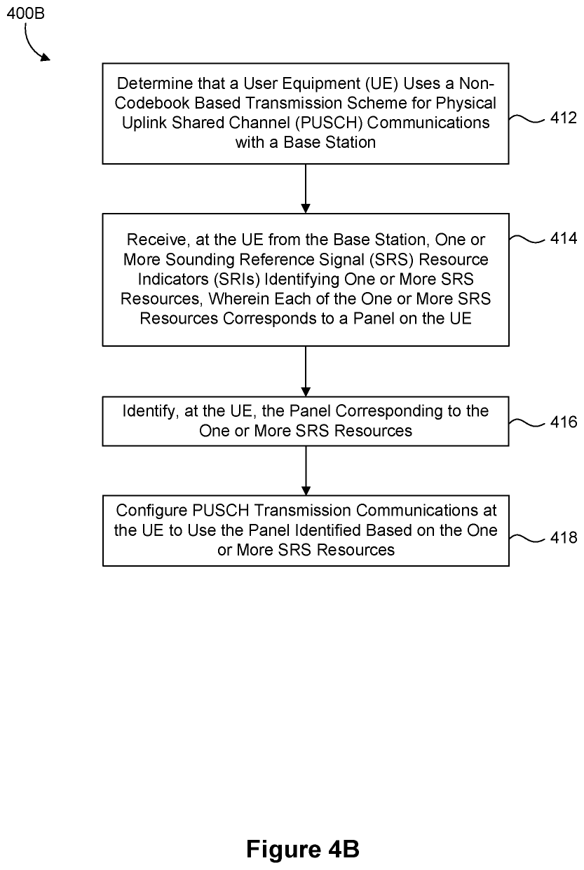

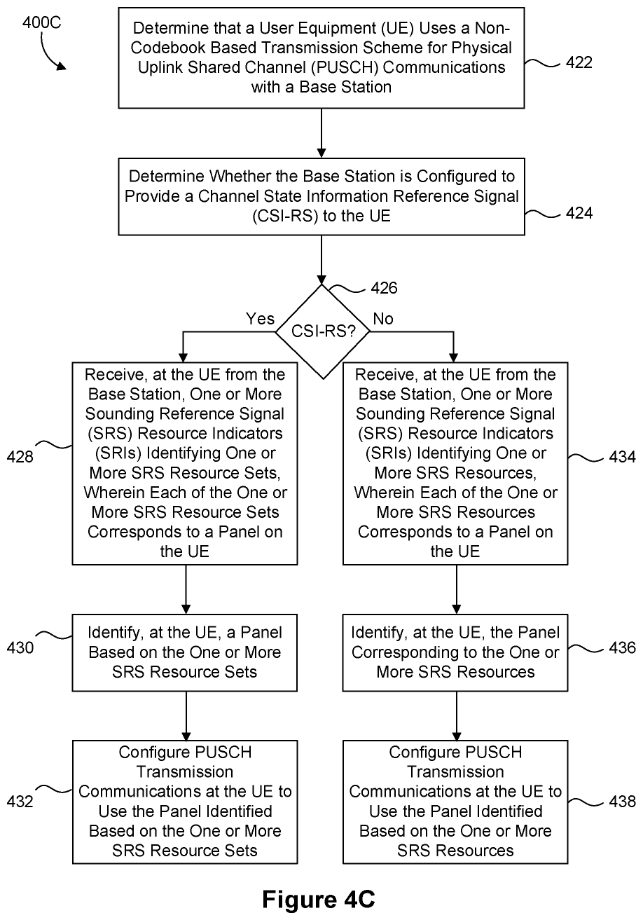

FIG. 4A illustrates a flowchart 400A for configuring non-codebook PUSCH communications using one or more SRS resource sets, according to some aspects. In some aspects, UE 110 may execute flowchart 400A. Flowchart 400A shall be described with reference to UE 110; however, flowchart 400A is not limited to that example aspect. Flowchart 400A may be implemented by processor 165 (FIG. 1B). For example, processor 165 may execute instructions, stored in memory 185, to perform the functions described in flowchart 400A. Alternatively, processor 165 may be “hard-coded” to perform these functions. Additionally, flowchart 400A may be executed on any computing device, such as, for example, the computer system described with reference to FIG. 8 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 4A, as will be understood by a person of ordinary skill in the art.

At 402, UE 110 may determine that the UE 110 uses a non-codebook (NCB) based transmission scheme for physical uplink shared channel (PUSCH) communications with a base station 120. This may occur in a manner similar to 202. For example, base station 120 may transmit an indication to UE 110 configuring UE 110 to use a NCB based transmission scheme. In some aspects, UE 110 may be pre-configured to use a NCB scheme for PUSCH communications. The precoder used for the NCB scheme may be derived based on a corresponding CSI-RS configured by base station 120. In some aspects, for the NCB scheme, each SRS resource may be configured for a single antenna port.

At 404, UE 110 may receive, from base station 120, one or more sounding reference signal (SRS) resource indicators (SRIs) identifying one or more SRS resource sets, wherein each of the one or more SRS resource sets corresponds to a panel on the UE. In some aspects, base station 120 may configure one or more SRS resource sets. The number of SRS resources in a SRS resource set may be less than or equal to a maximum number of antenna ports of the panel corresponding to the SRS resource set. In some aspects, a number of SRS resources may exceed a maximum number of antenna ports on the panel. This maximum number may be “N.” In this case, base station 120 may identify the first “N” SRS resources as valid for SRS indication. Base station 120 may then provide one or more SRIs corresponding to the identified SRS resources. The one or more SRIs may select the one or more SRS resources within a particular set from the multiple SRS resource sets. By identifying the particular SRS resource set corresponding to the SRIs, UE 110 may also identify the corresponding panel to be used for PUSCH communications.

At 406, UE 110 may identify a panel based on the one or more SRS resource sets. UE 110 may identify the panel based on the received one or more SRIs. As previously explained, the panel may correspond to the identified valid SRS resource set. At 408, UE 110 may configure PUSCH transmission communications to use the panel identified based on the one or more SRS resource sets.

FIG. 4B illustrates a flowchart 400B for configuring non-codebook PUSCH communications using one or more SRS resources, according to some aspects. In some aspects, UE 110 may execute flowchart 400B. Flowchart 400B shall be described with reference to UE 110; however, flowchart 400B is not limited to that example aspect. Flowchart 400B may be implemented by processor 165 (FIG. 1B). For example, processor 165 may execute instructions, stored in memory 185, to perform the functions described in flowchart 400B. Alternatively, processor 165 may be “hard-coded” to perform these functions. Additionally, flowchart 400B may be executed on any computing device, such as, for example, the computer system described with reference to FIG. 8 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 4B, as will be understood by a person of ordinary skill in the art.

At 412, UE 110 may determine that the UE 110 uses a non-codebook (NCB) based transmission scheme for physical uplink shared channel (PUSCH) communications with a base station 120. This may occur in a manner similar to 202. For example, base station 120 may transmit an indication to UE 110 configuring UE 110 to use a NCB based transmission scheme. In some aspects, UE 110 may be pre-configured to use a NCB scheme for PUSCH communications. The precoder used for the NCB scheme may be derived based on a corresponding CSI-RS configured by base station 120. In some aspects, for the NCB scheme, each SRS resource may be configured for a single antenna port.

At 414, UE 110 may receive, from base station 120, one or more sounding reference signal (SRS) resource indicators (SRIs) identifying one or more SRS resources, wherein each of the one or more SRS resources corresponds to a panel on the UE. In some aspects, base station 120 may configure multiple SRS resources. Different SRS resources may be associated with the same panel. This may be determined based on the beam indication for each SRS resource. In some aspects, the number of SRS resources associated with a panel may be less than or equal to a number of antenna ports corresponding to the panel. Similar to 404, in some aspects, a number of SRS resources may exceed a maximum number of antenna ports on a panel. This maximum number may be “N.” In this case, base station 120 may identify the first “N” SRS resources as valid for SRS indication. In some aspects, the first N SRS resources may correspond to the SRS resources having the lowest index or identification values. Base station 120 may then provide one or more SRIs corresponding to the identified SRS resources.

At 416, UE 110 may identify a panel based on the one or more SRS resources. UE 110 may identify the panel based on the received one or more SRIs. As previously explained, the panel may correspond to the identified valid SRS resources. At 418, UE 110 may configure PUSCH transmission communications to use the panel identified based on the one or more SRS resources.

FIG. 4C illustrates a flowchart 400C for configuring non-codebook PUSCH communications based on whether a channel state information reference signal (CSI-RS) is used, according to some aspects. In some aspects, UE 110 may execute flowchart 400C. Flowchart 400C shall be described with reference to UE 110; however, flowchart 400C is not limited to that example aspect. Flowchart 400C may be implemented by processor 165 (FIG. 1B). For example, processor 165 may execute instructions, stored in memory 185, to perform the functions described in flowchart 400C. Alternatively, processor 165 may be “hard-coded” to perform these functions. Additionally, flowchart 400C may be executed on any computing device, such as, for example, the computer system described with reference to FIG. 8 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 4C, as will be understood by a person of ordinary skill in the art.

At 422, UE 110 may determine that the UE 110 uses a non-codebook (NCB) based transmission scheme for physical uplink shared channel (PUSCH) communications with a base station 120. This may occur in a manner similar to 202. For example, base station 120 may transmit an indication to UE 110 configuring UE 110 to use a NCB based transmission scheme. In some aspects, UE 110 may be pre-configured to use a NCB scheme for PUSCH communications. The precoder used for the NCB scheme may be derived based on a corresponding CSI-RS configured by base station 120. In some aspects, for the NCB scheme, each SRS resource may be configured for a single antenna port.

At 424, UE 110 may determine whether base station 120 is configured to provide a CSI-RS to UE 110. As previously explained, the CSI-RS is used by UE 110 to determine channel quality. In some aspects, the NCB precoder may be derived from the CSI-RS signal. The presence or absence of the CSI-RS may determine how a precoder is selected for PUSCH communications. At 426, the presence or absence of the CSI-RS may determine whether base station 120 configures SRS resources or SRS resource sets. As further described below, when base station 120 provides a CSI-RS, UE 110 may be configured based on SRS resource sets. This may occur similar to flow chart 400A as described with reference to FIG. 4A. When base station 120 has not provided a CSI-RS, UE 110 may be configured based on SRS resources. This may occur similar to flow chart 400B as described with reference to FIG. 4B.

When base station 120 provides a CSI-RS, UE 110 may be configured using identified SRS resource sets at 428, 430, and 432. At 428, UE 110 may receive, from base station 120, one or more sounding reference signal (SRS) resource indicators (SRIs) identifying one or more SRS resource sets, wherein each of the one or more SRS resource sets corresponds to a panel on the UE. This may occur similar to 404 as described with reference to FIG. 4A. At 430, UE 110 may identify a panel based on the one or more SRS resource sets. UE 110 may identify the panel based on the received one or more SRIs. As previously explained, the panel may correspond to the identified valid SRS resource set. At 432, UE 110 may configure PUSCH transmission communications to use the panel identified based on the one or more SRS resource sets.

When base station 120 does not provide a CSI-RS, UE 110 may be configured using identified SRS resources at 434, 436, and 438. At 434, UE 110 may receive, from base station 120, one or more sounding reference signal (SRS) resource indicators (SRIs) identifying one or more SRS resources, wherein each of the one or more SRS resources corresponds to a panel on the UE. This may occur similar to 434 as described with reference to FIG. 4B. At 436, UE 110 may identify a panel based on the one or more SRS resources. UE 110 may identify the panel based on the received one or more SRIs. As previously explained, the panel may correspond to the identified valid SRS resources. At 438, UE 110 may configure PUSCH transmission communications to use the panel identified based on the one or more SRS resources.

FIG. 6 illustrates a flowchart 600 for applying prioritization scheduling at a UE using different panels for SRS and PUSCH communications, according to some aspects. In some aspects, UE 110 may execute flowchart 600. Flowchart 600 shall be described with reference to UE 110; however, flowchart 600 is not limited to that example aspect. Flowchart 600 may be implemented by processor 165 (FIG. 1B). For example, processor 165 may execute instructions, stored in memory 185, to perform the functions described in flowchart 600. Alternatively, processor 165 may be “hard-coded” to perform these functions. Additionally, flowchart 600 may be executed on any computing device, such as, for example, the computer system described with reference to FIG. 8 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 6, as will be understood by a person of ordinary skill in the art.

At 602, UE 110 may determine that the UE 110 communicates with base station 120 using different panels for sounding reference signal (SRS) and physical uplink shared channel (PUSCH) communications. For example, one or more panels may be used for transmitting a SRS to base station 120 while a different set of one or more panels may be used to transmit PUSCH communications to base station 120. In some aspects, SRS and PUSCH communications at UE 110 may be associated with different panels across component carriers (CCs) within a band. In this situation, simultaneous transmissions may not be supported. To avoid collisions, UE 110 may apply a dropping rule and/or a prioritization. These will be further described below. In some aspects, SRS and PUSCH communications at UE 110 may be associated with different panels across component carriers (CCs) across a band. In this case, UE 110 may be able to support simultaneous transmissions for SRS and/or PUSCH signals for some band combinations. When UE 110 is able to support simultaneous transmissions, UE 110 may report this capability to base station 120.

In some aspects, determining whether UE 110 is capable of supporting simultaneous transmissions maybe depend on whether a band shares the same antenna or does not share the same antenna for SRS and PUSCH communications. When the band shares the same antenna, UE 110 may not support simultaneous transmissions across panels. When the band does not share the same antenna, UE 110 may support simultaneous transmissions across the panels. As will be further described at 604, when a UE is not capable of supporting simultaneous transmissions, prioritization scheduling may be used to avoid signal collisions. In some aspects, this prioritization scheduling may also apply for handling collisions in the intra-band scenario as well.

At 604, UE 110 may apply prioritization scheduling to schedule PUSCH and SRS communications. As previously explained, this prioritization scheduling may aid in avoiding signal collisions. In some aspects, UE 110 may use a dropping rule. This dropping rule may be defined in UE 110. The dropping rule may be determined by the usage of SRS and/or a configuration of UE 110. Factors considered for this dropping rule may include whether the PUSCH communications are CB or NCB, the antenna switching or positioning that may be required, and/or a time domain behavior of the signals. For example, for a SRS transmitted by UE 110, the SRS may be aperiodic, semi-persistent, or periodic. This time domain behavior may be factored into the dropping rule and/or prioritization scheduling.

In some aspects, the content of PUSCH communications may be factored into the prioritization scheduling. For example, the PUSCH communications may include data only, data with uplink control information (UCI), UCI only, and/or UCI content. The UCI content may include Layer 1 Reference Signal Received Power (RSRP) data, channel state information (CSI) data, Layer 1 signal-to-noise and interference ratio (SINR) data, an acknowledgement, an indication of traffic type, and/or an indication of high or low traffic priority.

Based on these factors related to PUSCH and/or SRS communications, UE 110 may prioritize the scheduling of the communications. In an example aspect, which is non-limiting, an example prioritization may be sequenced as: PUSCH with UCI; PUSCH with data; aperiodic SRS; semi-persistent SRS; periodic SRS. In some aspects, different prioritization scheduling may be used based on the above factors.

In some aspects, the prioritization scheduling may be configured by higher layer signaling. For example, base station 120 may provide Radio Resource Control (RRC) data, a MAC CE, or a DCI to configure the priority. In some aspects, the RRC, MAC CE, and/or DCI may be provided for each channel or SRS resource. This may address the scenario where dynamic-grant (DG) or configured-grant (CG) based PUSCH communications are used. For example, higher layer signaling may configure a priority for a periodic signal and/or a CG-PUSCH. In some aspects, a scheduling DCI may be used to configure a priority for an aperiodic signal and/or a DG-PUSCH.

In some aspects, the prioritization scheduling may consider collisions as errors. For example, UE 110 may avoid simultaneously transmitting SRS and PUSCH communications. In this case, the base station 120 may apply a scheduling restriction to avoid errors. UE 110 may then use the scheduling restriction supplied by base station 120. In some aspects, UE 110 may use a dropping rule to avoid the error.

In some aspects, a combination of dropping rules, priority scheduling, and/or error determinations may be used for prioritization scheduling. Some situations may be defined as an error case while others may be addressed via a dropping rule or priority configured by base station 120. For example, in the case where PUSCH communications are scheduled with other PUSCH communications, UE 110 may identify this as an error case. When SRS communications are scheduled with other SRS communications, however, a dropping rule or priority configured by the base station 120 may be applied. In this manner, a combination of dropping rules, priority scheduling, and/or error determinations may be used.

Applying the prioritization scheduling at 604 may allow UE 110 to avoid collisions when simultaneous transmissions are not supported. This may apply for CCs in an intra-band situation as well.

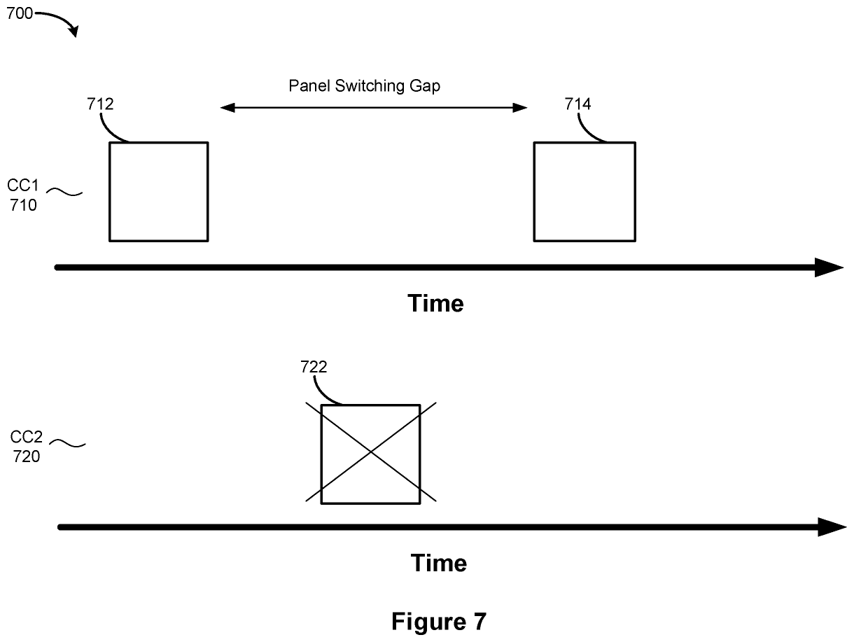

In some aspects, another factor for determining the prioritization scheduling may depend on transition delays for panel activation and/or panel switching. For example, UE 110 may activate or switch to another panel for SRS or PUSCH communications. There may be a time delay associated with this transition. To address the time delay, UE 110 adjust the prioritization scheduling. In some aspects, UE 110 may implement a rule where UE 110 may not transmit any uplink signal during the transition delay. In this case, UE 110 may drop the uplink signal. This situation is further described with reference to FIG. 7. In some aspects, UE 110 may transmit the uplink signal. For example, the capabilities of UE 110 may support transmission of an uplink signal during the transition delay. For example, this may be via another antenna and/or panel. In some aspects, UE 110 may report to base station 120 whether UE 110 is capable of transmitting during the transition delay. In some aspects, different prioritization options may be selected for intra-band or inter-band CCs. This may occur when SRS/PUSCH communications are associated with different panels across CCs.

At 606, UE 110 may switch between the different panels according to the prioritization scheduling to communicate with base station 120. As previously explained, this communication may be SRS and/or PUSCH communications. The panel switching and/or activation may occur because the SRS and/or PUSCH communications may occur on different panels. Using the prioritization scheduling, UE 110 may avoid potential collisions with the transmissions.

As previously explained, in some aspects, a transition delay may occur during panel switching or activation. FIG. 7 provides an example of this transition delay. FIG. 7 illustrates a block diagram 700 of uplink signal dropping during panel switching, according to some aspects. For example, a first component carrier (CC) 710 may be used to communicate with base station 110. At time 712, UE 110 may determine that panel switching is needed. For example, beam indication signaling may cause UE 110 to switch panels. In some aspects, although the panel may be switched, UE 110 may still communicate using CC 710. A panel switching gap, however, may correspond to the amount of time used by UE 110 to switch panels. This panel switching gap may extend to time 714 when UE 110 has switched panels and is prepared to continue communications using CC 710.

During the panel switching gap, however, an uplink communication may be scheduled on a second CC 720. This uplink communication may have been scheduled at time 722. If UE 110 is configured to drop such signals during the panel switching gap, however, UE 110 may not transmit this uplink communication. In this case, UE 110 may avoid transmitting this uplink communication even though it uses a different CC 720. This dropping of an uplink communication may occur at 606.

FIG. 8 depicts an example computer system useful for implementing various aspects. Various aspects may be implemented, for example, using one or more well-known computer systems, such as computer system 800 shown in FIG. 8. One or more computer systems 800 may be used, for example, to implement any of the aspects discussed herein, as well as combinations and sub-combinations thereof.

Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, etc., which may communicate with communication infrastructure 806 through user input/output interface(s) 802.

One or more of processors 804 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 8. In particular, aspects can operate with software, hardware, and/or operating system implementations other than those described herein.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described can include a particular feature, structure, or characteristic, but every aspect can not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

1. A method, comprising:
receiving, at a user equipment (UE) from a base station, an indication of whether to use a codebook based transmission scheme or a non-codebook based transmission scheme for physical uplink shared channel (PUSCH) communications with the base station;
receiving, at the UE from the base station, an indication of one or more sounding reference signal (SRS) resources corresponding to whether the UE uses the codebook based transmission scheme or the non-codebook based transmission scheme;
identifying, at the UE, a panel including one or more antenna ports corresponding to the one or more SRS resources; and
configuring, at the UE, PUSCH transmission communications to use the panel including the one or more antenna ports.

2. The method of claim 1, wherein the UE uses a codebook based transmission scheme and wherein the receiving further comprises:
receiving, at the UE, a list identifying the one or more antenna ports of the UE for a SRS resource.

3. The method of claim 1, wherein the UE uses a codebook based transmission scheme and wherein the receiving further comprises:
receiving, at the UE, one or more SRS resource indicators (SRIs) identifying the one or more SRS resources corresponding to the panel.

4. The method of claim 1, wherein the UE uses a codebook based transmission scheme and wherein the receiving further comprises:
receiving, at the UE, one or more SRS resource indicators (SRIs) identifying one or more SRS resource sets corresponding to the panel, wherein the one or more SRS resource sets include the one or more SRS resources.

5. The method of claim 1, wherein the UE uses a codebook based transmission scheme and wherein the receiving further comprises:
receiving, at the UE, a medium access control control element (MAC CE) or a downlink control information (DCI) message indicating one or more antenna ports corresponding to the one or more SRS resources.

6. The method of claim 1, wherein the UE uses a non-codebook based transmission scheme and wherein the receiving further comprises:
receiving, at the UE, one or more SRS resource indicators (SRIs) identifying one or more SRS resource sets corresponding to the panel, wherein the one or more SRS resource sets include the one or more SRS resources.

7. The method of claim 6, the method further comprising:
receiving, at the UE from the base station, a channel state information reference signal (CSI-RS); and
in response to receiving the CSI-RS, receiving, at the UE, the one or more SRIs identifying the one or more SRS resource sets.

8. The method of claim 1, wherein the UE uses a non-codebook based transmission scheme and wherein the receiving further comprises:
receiving, at the UE, one or more SRS resource indicators (SRIs) identifying the one or more SRS resources corresponding to the panel.

9. The method of claim 8, wherein receiving the one or more SRIs identifying the one or more SRS resources occurs when a channel state information reference signal (CSI-RS) has not been received from the base station.

10. A user equipment (UE), comprising:
one or more panels;
a transceiver coupled to the one or more panels; and
at least one processor coupled to the transceiver, wherein the at least one processor is configured to:
receive, from a base station via the transceiver, an indication of whether physical uplink shared channel (PUSCH) communications with the base station are implemented using a codebook based transmission scheme or a non-codebook based transmission scheme;
receive, from the base station via the transceiver, an indication of one or more sounding reference signal (SRS) resources corresponding to the codebook based transmission scheme or the non-codebook based transmission scheme;
identify a panel from the one or more panels including one or more antenna ports corresponding to the one or more SRS resources; and
configure PUSCH transmission communications to use the panel including the one or more antenna ports.

11. The UE of claim 10, wherein a first panel of the one or more panels has a same or different number of antenna ports than a second panel of the one or more panels.

12. A method, comprising:
determining, at a user equipment (UE), that one or more first panels of the UE are used for transmitting a sounding reference signal (SRS) to a base station and one or more second panels of the UE are used for transmitting physical uplink shared channel (PUSCH) communications to the base station, wherein the one or more first panels differ from the one or more second panels;
applying, at the UE, prioritization scheduling to schedule the PUSCH and SRS communications; and
switching, at the UE, between the one or more first panels and the one or more second panels according to the prioritization scheduling to communicate with the base station.

13. The method of claim 12, wherein applying the prioritization scheduling further comprises:
prioritizing PUSCH communications before SRS communications.

14. The method of claim 12, wherein applying the prioritization scheduling further comprises:
prioritizing PUSCH communications with uplink control information (UCI) prior to PUSCH communications with data.

15. The method of claim 12, wherein applying the prioritization scheduling further comprises:
prioritizing aperiodic SRS prior to semi-persistent SRS or periodic SRS.

16. The method of claim 12, further comprising:
receiving, at the UE, a radio resource control (RRC), a medium access control control element (MAC CE), or a downlink control information (DCI) message from the base station configuring the prioritization scheduling; and
transmitting, from the UE, PUSCH communications to the base station based on the prioritization scheduling.

17. The method of claim 12, further comprising:
identifying, at the UE, a time delay corresponding to a switch from a first uplink panel to a second uplink panel;
identifying, at the UE, an uplink signal scheduled for transmission from the UE to the base station within the time delay; and
dropping, at the UE, the uplink signal such that the uplink signal is not transmitted during the time delay.

18. The method of claim 17, wherein the first and second uplink panels correspond to a first component carrier (CC) and wherein the uplink signal corresponds to a second CC different from the first CC.

19. The method of claim 12, further comprising:
identifying, at the UE, a time delay corresponding to a switch from a first uplink panel to a second uplink panel;
identifying, at the UE, an uplink signal scheduled for transmission from the UE to the base station within the time delay; and
transmitting, from the UE, the uplink signal during the time delay using an antenna supporting simultaneous transmissions across the one or more first panels and the one or more second panels.

20. The method of claim 12, further comprising:
transmitting, from the UE to the base station, an indication of whether the UE supports simultaneous transmission of uplink signals.
